(19) United States
(12) Patent Application Publication
(10) Pub. No.: US 2015/0133015 A1
(43) Pub. Date: May 14, 2015

(54) COATING MATERIAL

(71) Applicant: SUMICOL S.A., Medellin (CO)

(72) Inventors: Cesar Yuberney Cano Carrasquilla, Bello (CO); Juan Fernando Arango Londoño, Medellin (CO)

(73) Assignee: SUMICOLL S.A., Medellin, CO (US)

(21) Appl. No.: 14/401,264

(22) PCT Filed: May 15, 2013
(86) PCT No.: PCT/IB2013/053992

§ 371 Date: Nov. 19, 2014

(30) Foreign Application Priority Data
May 16, 2012 (CO) 12080851

(51) Int. Cl. D06N 3/04; D06N 3/14; D06N 3/00; B05D 1/28; B05D 1/36

(52) U.S. Cl. CPC D06N 3/042; B05D 1/28; B05D 1/36; D06N 3/0011; D06N 3/14
USPC 442/71; 427/412

(57) ABSTRACT

The present invention relates to a coating material that comprises a nonwoven fabric composed of polyester, polyolefin or natural fibers bonded together by a first binder and a coating comprised of a second binder applied on one of the surfaces of the fabric, wherein the first and second binders are functionally equivalent. The material of the present invention provides an adequate surface protection by being waterproof, water vapor proof, self-cleaning and resistant to light foot traffic.

The invention also refers to a process to obtain the coating material which comprises a first stage of obtaining the nonwoven fabric composed of polymeric fibers, followed by the application of a binder onto the nonwoven fabric to bind the fibers and a final stage wherein a second binder is applied to one of the fabric's surfaces.

### FIELD OF THE INVENTION

The present invention relates to a coating material, wherein said preferred embodiment, comprises a nonwoven fabric conformed by polymeric fibers which adhere to each other by means of a binder and a coating comprised of a second binder which is applied on one of the fabric's surfaces, wherein the first and second binder are functionally equivalent.

The invention also refers to a process to obtain a coating material which comprises an initial stage of obtaining a nonwoven fabric conformed by polymeric fibers, followed by the application of the binder onto the nonwoven fabric in order for these to adhere to the fibers, and finally applying a coat of the second binder onto one of the fabric's surfaces.

### BACKGROUND OF THE INVENTION

Within the constructive process context, which promotes comfort and ensures habitability quality in buildings and other productive sectors, one of the most considered and analyzed aspects is related to the protection and waterproofing of surfaces, which aims to reduce the effects related to water seepage.

The coating and protection of surfaces such as floors, roofs, decks, walls, pools, reservoirs, tiles, tanks, among others, is very important in the construction industry due to the effects caused by water intrusion, internal temperature increases and derived problems such as corrosion, paint peeling, mold and structural foundation deterioration. Said moisture causes not only economic loss but can also generate health problems.

Existing prefabricated materials for surface coating are generally made with multiple composite polyurethane, asphalt or bitumen mixtures which are manufactured layer by layer, wherein each of these layers provide a specific property such as water resistance, adhesiveness, reinforcement, decoration and reflectance.

Asphalt mantles have become one of the most widely used waterproofing systems because it is a prefabricated material that does not depend on curing times and environmental conditions for installation. However, these mantles have their own disadvantages such as low resistance to temperature changes and deterioration due to structural settlement.

The application of asphalt or bituminous materials has harmful effects on the environment since they contain volatile organic compounds and also require full or partial melting of the material for installation, which involves the use of hot liquids, torches or blow torches, which can cause risk of injury to the installer and fires.

With the development of acrylic resins, although some properties are improved in waterproofing performance when compared to asphalt mantles, a disadvantage was generated during its installation process, given application directly depends on weather conditions which must necessarily be dry and preferably on sunny days, and which during curing time, that can be up to 36 hours, rain must be absent.

There has been a recent development in coating technologies with liquid waterproofing properties, which may be resistant to traffic and in accordance with the amount and type of application, it may or may not reflect light. When applied in situ, the effectiveness of the coating depends on the skill of the installer, as several coats of liquid with long periods of drying time between each one must be manually applied, which significantly increases the time of work and exposure to adverse weather conditions, especially on external surfaces. The protection thus depends on the installer's ability to provide an even coating, which increases the risk that a poor aesthetic appearance results and fails to protect the surface due to peelings or seepage.

Prefabricated materials are generally made up of several layers, in which detachment may occur after being cut for installation. In some cases, said materials are not flexible enough, which make it difficult to apply onto two dimensional or three dimensional shapes such as corners and joints, which demand frequent maintenance.

There is a need to provide a coating material which is impermeable, preferably a single layer, with high water resistance, with a suitable vapor permeability and good structural integrity, which would represent a more efficient and economical solution for surface protection.

The present invention intends to unify performance advantages presented by waterproofing acrylics together with the benefits of asphalt coats, which results in a product that can meet waterproofing properties effectively and that its installation is quick, safe and not dependent of weather variations.

The coating material of the present invention ensures adequate surface protection given it is waterproof, vapor permeable, self-cleaning, resistant to light foot traffic and puddle resistant. Furthermore, the inclusion of optional elements in their composition adds other features to the material, allowing it to be reflective of natural and infrared light, a heat and sound insulator, flame retardant, self-adhesive and/or a decorative material. The material may preferably be in the form of a roll, a film, tapes and the like, in various two and three dimensional shapes.

### STATE OF THE ART

Various waterproofing materials have been developed, mostly multilayer coating of surfaces, materials, parts and objects that must be kept dry.

WO2011041263 discloses a multilayer membrane, which may be rolled, comprising three layers: a support layer of high density polyethylene, a pressure sensitive adhesive layer, preferably a styrene-isoprene-butadiene copolymer and a third protective layer composed of PVA and softened by acrylic polymers. By comprising three layers, its flexibility is limited and has many disadvantages due to detachment of the layers when cut for installation.

Application EP2177349 discloses a flexible multilayer membrane wherein a first polyethylene layer, acting as a moisture barrier, and another compound layer allows it to combine with the liquid concrete to bind when dry. The layers are joined by a hot melt sealant solid (acrylate, polyurethane, silane, polyolefins), which require high temperatures and the use of torches to be installed.

WO2011139466 discloses a waterproofing membrane comprising a support sheet, a pressure sensitive layer on top of one surface of the adhesive support sheet and a protective coating layer on top of the adhesive layer. The protective coating layer is highly reflective (optionally with texture) and is suitable as a concrete binder. The protective coating layer comprises cement, polymer, and white pigment, and optionally a filler agent, a UV absorbent and an antioxidant. Although this membrane has excellent properties such as reflectance and thermal insulation, resistance to deterioration is very poor.

### DESCRIPTION OF THE FIGURES

FIG. 1: A photograph of the coating material of the present invention is observed, wherein a single homogeneous layer is shown. The dark section of the upper part of the photograph corresponds to an optical effect and not a material transition.

FIG. 2: A photograph of the synthetic TPO polyolefin (Texa) membrane, containing 2 layers, is observed.

FIG. 3: A photograph of a prefabricated impermeable coating (Mapeguard®), containing 3 layers, is observed.

FIG. 4: A photograph of another prefabricated impermeable coating (Geomembrana® Tanques), containing 2 layers, is observed.

FIG. 5: A photograph of another prefabricated impermeable coating (Geomembrana® Piscinas), containing 2 layers, is observed.

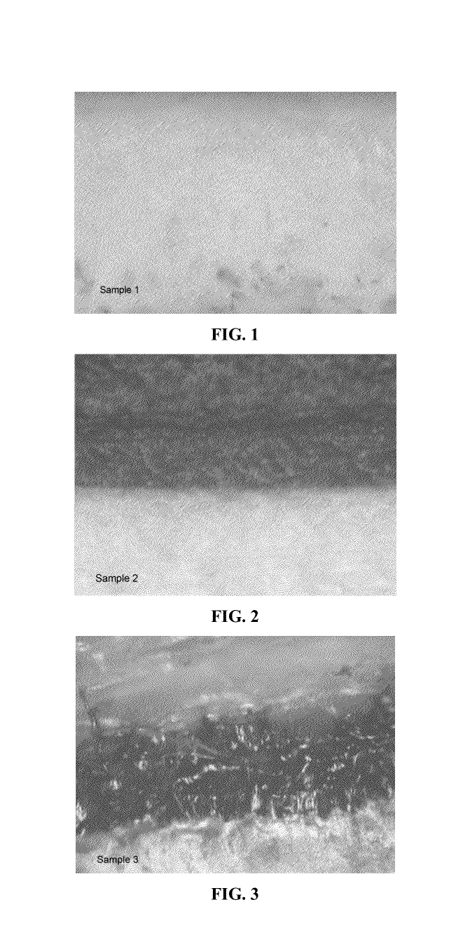

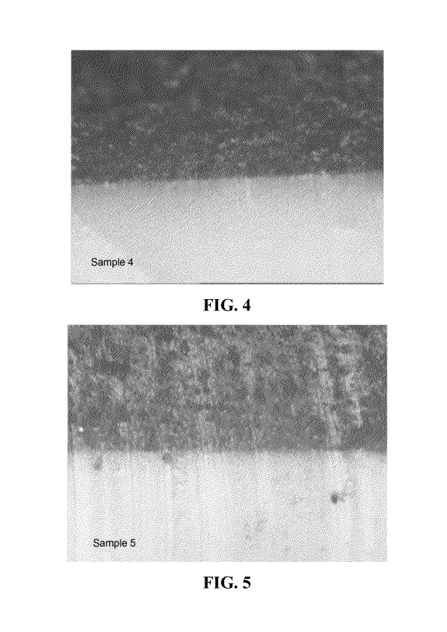

### DETAILED DESCRIPTION

In a first embodiment, the present invention relates to a monolithic coating material comprising a nonwoven fabric composed of polyester, polyolefin or natural fibers bonded together by a binder and a coating comprised of a second binder applied on one face of the fabric, wherein the first and second binders are functionally equivalent.

The term “functionally equivalent” is defined as the ability to form a monolith, where the components can be of the same chemical nature or compatible in terms of adhesion between the formulations (acrylic, styrenated acrylic, urethane or mixtures thereof), such that no interface (contact) or fault plane in the interface (or its vicinities) which may mechanically weaken the material and avoids delamination along the interface is generated.

In a preferred embodiment, the coating material of the present invention is obtained from polyethylene terephthalate fibers which are immersed in acrylic resin solutions which act as binders for textile fibers, following a process that facilitates binding between the fibers and the resin, resulting in an acrylic coating reinforced with fibers, which can be obtained in various shapes, sizes, lengths and thicknesses.

The nonwoven fabric material of the present invention may consist of polyester fibers such as polyethylene terephthalate. Polyethylene terephthalate, known for its acronym PET, belongs to the group of synthetic materials called linear polyesters and it is a thermoplastic polymer with a high degree of crystallinity which is widely used in the textile and beverage container industry. PET is obtained by a polycondensation reaction between terephthalic acid and ethylene glycol. Like all thermoplastic materials, these can be processed by extrusion, injection, blow molding, preform blowing and thermoforming.

Acrylic resins provide materials water repellency (waterproofing) and water vapor permeability properties, while other additional compounds such as lighteners, biocides, aluminum hydroxide or pigments, will provide reflectant, thermal insulating and decorative characteristics. Due to its features, the coating material of the present invention can be installed regardless of the environmental conditions at the place of application, because it does not require any curing time, it is cold implemented and does not require high temperatures for installation.

In one embodiment of the claimed coating material, two formulations of functionally equivalent binders are used. The first binder formulation (formulation A), used to bind the fibers of the nonwoven fabric, comprises carbonates, thickener acrylic resins, wetting agents, coalescing agents and coupling agents. The second binder formulation (formulation B), which is applied on one surface of the fabric, contains the same elements of the formulation of the first binder, and optionally other compounds such as titanium dioxide, lighteners, biocides or pigments.

By varying the content of associative and urethane based thickeners, the rheological characteristics of each of the formulations A and B may be modified in order to adjust the manufacturing process and the characteristics of the fibers employed.

In order to obtain the monolithic coating material, a low resistance nonwoven fabric is firstly formed from polyester fibers, preferably randomly crosslinked, during a randomization process. The nonwoven fabric of the present invention can be obtained by different methods, including by dry laid, wet laid, air laid or the like, so that a random orientation of the fibers is ensured for higher structural tensile strength when the coating material is formed.

The predefined polyester fiber nonwoven fabric is now subject to a padding process where two rollers impregnate the fabric with the binder of Formulation A and it then goes through the drying rolls which are pressurized with steam to ensure drying.

Following, the Formulation B binder is added in the application (mirror roller), which is responsible for spreading the material along the roller, and a blade defines the thickness of the binder to be applied. Finally, the material is subject to a heat treatment with hot air at a temperature of about 70° C. at a rate to ensure adequate drying and to provide a finished desired texture of the material.

The binders of the present invention may include the following raw materials: guar or starch ether thickeners, silicone or mineral oil antifoaming agents, hydrophobic dispersants, moisturizers from the glycol family (propylene glycol, ethylene glycol, butyl glycol), coupling agents from the silane family, different colored mineral or organic pigments, ceramic microspheres, mineral nature lighteners (borosilicate, perlite) or organic nature lighteners such as urethane based or styrenated acrylic based polymers, coalescents, acrylic or urethane thickeners; flame retardants such as aluminum hydroxide or magnesium hydroxide, chlorinated paraffin or organophosphorous compounds.

The resins may be, preferably, of a pure acrylic or styrenated acrylic nature such as, for example, Rhoplex® EC 1791 (DOW) 2002 Acriten® (Sygla) and Texilan® 562 (Andercol).

Formulations, especially Formulation B, may include titanium dioxide between 0.1% and 1.0% by weight to produce biocide effects by photocatalytic action and self-cleaning by a superhydrophilicity effect. This allows for surface sealing to be functionalized in regards to the material of the instant invention. Similarly, one can functionalize the surface material of the invention, increasing the titanium dioxide content of Formulation B up to 8.0%, whereby a better coating at lower cost is obtained.

A more reflective surface thus obtained allows a decrease in temperature on the support coating which decreases both damaging effects due to thermal expansion and the energy consumption of environmental conditioning equipment inside a building. Similarly, the addition of plastic 40 μm microspheres (Expancel ® from Akzo Nobel), within a 0.1% to 0.7% of the composition, allows a decrease of the emittance of the material surface at lower manufacturing cost compared to the addition to the total mass of the product with said microspheres.

Quality tests are performed on the completed material in order to verify viscosity properties, solid content; density, pH, application tests on a base material for a qualitative observation on applicability, covering power and presence of lumps. The compound is packed in containers for easy handling in the process of shaping the waterproof material.

The coating material of the present invention may be installed on a substrate by various methods known in the art, such as ballast (including a load thereon), mechanical attachment (screws) or by direct attachment. In the latter case, a formulation similar to Formulation A or Formulation B may be placed on the carrier which serves as an adhesive between the surface and the coating material of the present invention.

To facilitate application on a surface, one or more components of adhesives or surface contact to facilitate contact or surface pressure such as Adhetac® HB70 may be incorporated onto the material coating of the present invention.

### EXAMPLES

The invention is explained in greater detail through the following examples, wherein the inventive concept is not restricted to them.

### Example 1

A nonwoven fabric is prepared using 38 millimeter long and 0.1 millimeter diameter PET fibers, by randomizing the fibers until a final weight of the fabric is between 120 and 180 grams/m² and a thickness between 0.50 and 0.70 millimeters is obtained.

In the preparation of the first binder (Formulation A) a mixture of 33.7% water, 0.16% cellulose ether thickener, 0.4% antifoaming agent, 1.5% dispersant, 0.7% wetting agent, 0.20% silane, 0.1% fungicide algaecide, 41.6% calcium carbonate, 20.6% pure acrylic emulsion, 0.5% coalescent and 0.1% associative thickener is prepared in Cowlex type disperser in order to provide the necessary agitation to obtain a homogeneous mixture.

In the preparation of the second binder (Formulation B) a mixture is also made in a Cowlex type disperser with the following components: 15.0% water, 0.4% cellulose ether thickener, 0.5% antifoaming agent, 1.4% dispersant, 1.4% wetting agent, 0.2% silane, 0.1% fungicide algaecide, 2.0% titanium dioxide, 36.0% calcium carbonate, 40.0% pure acrylic emulsion, 1.1% coalescent, 0.8% associative thickener and 0.5% biocide.

The nonwoven fabric is impregnated with the formulation A by means of a Foulard process. Once impregnated, it passes through drying towers where the mixture components are structurally consolidated. The temperature of the rollers may vary between 130° C. and 145° C., and the manufacturing speed may be between 1 and 2 meters/second.

Subsequently, Formulation B is incorporated by the knife over roller method, whereby the pores are sealed and the thickness is adjusted between 1.20 and 1.50 millimeters, thus obtaining a smooth and uniform finish. The finished material is passed through a drying oven with hot air recirculation between 70° C. and 80° C. at a rate of 1.5 meters/second.

### Example 2

In another preferred embodiment, Formulation B is mixed with 3% by weight 38 mm long and 0.1 mm diameter PET fibers. The material thus obtained is placed on a conveyor belt, where a blade spreads the product and provides the desired thickness, and later subject to oven drying at a temperature between 60° C. and 70° C. Formulation A or Formulation B is then fed by the knife over roll method with which the pores are sealed and the 1.20 to 1.50 mm thickness is set. Finally, the material is passed through a drying oven with recirculating air between 70° C. and 80° C. at a rate of 1.5 meters/second.

### Efficacy/Performance Tests

The following tests were performed on the coating material of Example 1 of the present invention, and were compared to other waterproofing products.

a)
Pressurized water absorption test according to EN12390-8 standard

| | Membrane | Pres- | | | |
|---|---|---|---|---|---|
| | thickness | sure | | Approval yes/no | |
| Product | (mm) | (bar) | Time (days) | 7 days | 14 days |
| EXAMPLE 1 | 1.10 | 1.5 b | 7 and 14 days | Yes | Yes |
| SIKAFILL ® | 2.37 | 1.5 b | 7 and 14 days | Yes | Yes |
| ELASTOSIL ® | 2.22 | 1.5 b | 7 and 14 days | Yes | No |
| PARAGUAS ® | 2.34 | 1.5 b | 7 and 14 days | Yes | Yes |

b)
Elongation tests according to ASTM D6083 standard

| | | Maximum tensile stress |
|---|---|---|
| Product | Elongation % | kg/cm² |
| EXAMPLE 1 | 83 | 58.9 |
| SIKAFILL ® | 402 | 11.9 |
| ELASTOSIL ® | 140 | 22.5 |
| PARAGUAS ® | 353 | 14.6 |

c)
Water absorption according to ASTM D6083 standard

| | | Approved yes/no |
|---|---|---|
| Product | Water absorption % | After 7 days |
| EXAMPLE 1 | 9% | Yes |
| SIKAFILL ® | 35% | No |
| ELASTOSIL ® | 71% | No |
| PARAGUAS ® | 24% | No |

d)
Water vapor transmission according to ASTM D6083 standard

| | | Water vapor permeability |
|---|---|---|
| Product | Membrane thickness (mm) | g · m² · cm · d |
| EXAMPLE 1 | 1.10 | 6.7 |
| SIKAFILL ® | 0.77 | 2.3 |
| ELASTOSIL ® | 0.85 | 1.9 |
| PARAGUAS ® | 0.98 | 4.5 |

Modifications to the embodiments of the previously described invention may be appreciated by one skilled in the art and may be carried out without departing from the spirit of the invention, as set forth by the scope of the following claims.

1. A coating material characterized because it comprises:
a—a nonwoven fabric composed of fibers which are bonded together with a first binder; and
b—a coating compound of a second binder applied over one of the surfaces of said fabric;
wherein the first and second binders are functionally equivalent.

2. The coating material of claim 1, wherein the fibers are polyester fibers, polyolefin fibers, natural fibers and combinations thereof.

3. The coating material of claim 2, wherein the fibers are made from polyethylene terephthalate.

4. The coating material of claim 1, wherein the first and second binder are selected, in a separate and independent manner, from the group consisting of acrylic resins, polyurethane and combinations thereof.

5. The coating material of claim 1, wherein the first and second binder are an ethylenecarboxylic acid copolymer which is selected, in a separate and independent manner, from the group consisting of: ethylenecarboxylic acid, ethylenecarboxylic acid esters, styrenated ethylenecarboxylic acid esters and combinations thereof.

6. The coating material of claim 1, wherein the first and second binder consist of the same material.

7. The coating material of claim 1, wherein the binders are further mixed with calcium carbonate, silicone or cellulose ether.

8. The coating material of claim 1, wherein the binders further contain titanium dioxide, lighteners, biocides, aluminum hydroxide or pigments.

9. The coating material of claim 1, which may further contain an adhesive component for self-adhesive application effects.

10. A process to manufacture a coating material which comprises:
a. obtaining a fiber based nonwoven fabric;
b. applying a first binder to the nonwoven fabric to adhere the fibers;
c. applying a second binder layer over one of the surfaces of the fabric.

11. The process according to claim 10, wherein the fibers are polyester fibers, polyolefin fibers, natural fibers and combinations thereof.

12. The process according to claim 10, wherein the fibers are made from polyethylene terephthalate.

13. A process according to claim 10, wherein the first and second binder are selected, in a separate and independent manner, from the group consisting of acrylic resins, polyurethane and combinations thereof.

14. A process according to claim 10, wherein the first and second binder are an ethylenecarboxylic acid copolymer which is selected, in a separate and independent manner, from the group consisting of: ethylenecarboxylic acid, ethylenecarboxylic acid esters, styrenated ethylenecarboxylic acid esters and combinations thereof.

15. A process according claim 10, wherein the first and second binder consist of the same material.

16. A process according to claim 10, wherein the binder application onto the nonwoven fabric procedure is by means of the Foulard process.

17. A process according to claim 10, wherein the second binder layer application is by means of the knife over roll method.
